(19) United States
(12) Patent Application Publication
(10) Pub. No.: US 2024/0336107 A1
(43) Pub. Date: Oct. 10, 2024

(54) SEAT AIR CONDITIONER

(71) Applicant: Panasonic Automotive Systems Co., Ltd., Kanagawa (JP)

(72) Inventors: Tatehiko INOUE, Osaka (JP); Yuki MAKITA, Kanagawa (JP); Yoshihiko MAEDA, Hyogo (JP); Takeshi ENYA, Hyogo (JP); Takuya NAKAGAWA, Shiga (JP)

(21) Appl. No.: 18/745,673

(22) Filed: Jun. 17, 2024

Related U.S. Application Data
(63) Continuation of application No. PCT/JP2022/039852, filed on Oct. 26, 2022.

(30) Foreign Application Priority Data
Dec. 27, 2021 (JP) 2021-212458
Jul. 19, 2022 (JP) 2022-114603

(51) Int. Cl. B60H 1/00; B60H 1/24

(52) U.S. Cl. CPC B60H 1/00285; B60H 1/241

(57) ABSTRACT

The seat air conditioner is a seat air conditioner included in a seat including a seat back and a headrest that is height-adjustable and attached to an upper portion of the seat back and. The seat air conditioner includes: a blower provided inside the seat; a first blowing port and a second blowing port that are formed in the seat back for blowing out air blown from the blower from the seat back; and the headrest. The second blowing port is disposed below the first blowing port, and the first blowing port is opened and closed in conjunction with a height adjustment movement of the headrest.

### CROSS REFERENCE TO RELATED APPLICATIONS

This is a continuation application of PCT International Application No. PCT/JP2022/039852 filed on Oct. 26, 2022, designating the United States of America, which is based on and claims priority of Japanese Patent Application No. 2021-212458 filed on Dec. 27, 2021, and Japanese Patent Application No. 2022-114603 filed on Jul. 19, 2022.

### FIELD

The present disclosure relates to a seat air conditioner that blows air to a user seated on a seat.

### BACKGROUND

Conventionally, in a seat air conditioner that blows air to a user seated on a seat, a plurality of vents for blowing air to the user are arranged at different positions on the seat (for example, see Patent Literature (PTL) 1).

### CITATION LIST

### Patent Literature

PTL 1: Japanese Patent No. 6599170

### SUMMARY

However, the seat air conditioner according to PTL 1 can be improved upon.

In view of this, the present disclosure provides a seat air conditioner capable of improving upon the above related art.

A seat air conditioner according to an aspect of the present disclosure is a seat air conditioner included in a seat including a seat back and a headrest that is height-adjustable and attached to an upper portion of the seat back, the seat air conditioner including: a blower provided inside the seat; and a first blowing port and a second blowing port that are formed in the seat back for blowing out air blown from the blower from the seat back, wherein the second blowing port is disposed below the first blowing port, and the first blowing port is opened and closed in conjunction with the height adjustment movement of the headrest.

A seat air conditioner according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view showing an appearance of a seat including a seat air conditioner according to an embodiment.

FIG. 2 is an explanatory diagram showing the seat back and headrest in an open state according to the embodiment.

FIG. 3 is an explanatory diagram showing the seat back and headrest in a blocked state according to the embodiment.

FIG. 4 is an explanatory diagram showing a state in which a large user is seated on a seat in an open state according to the embodiment.

FIG. 5 is an explanatory diagram showing a state in which a small user is seated on a seat in a blocked state according to the embodiment.

FIG. 6 is an explanatory diagram showing the seat back and headrest in an open state according to Variation 1.

FIG. 7 is an explanatory diagram showing the seat back and headrest in a blocked state according to Variation 1.

FIG. 8 is an explanatory diagram showing a seat back and a headrest according to Variation 2.

FIG. 9 is an explanatory diagram showing a seat back and a headrest according to Variation 3.

FIG. 10 is an explanatory diagram showing another installation position of the active ingredient generator according to Variation 3.

### DESCRIPTION OF EMBODIMENT

The present inventors have found that the following problems occur regarding the seat air conditioner described in the “Background” section.

Although users of different physiques may sit on the seat, there is a possibility that the air blown out from each vent may not hit an appropriate position depending on the user. For this reason, the present disclosure provides a seat air conditioner that can blow air to an appropriate position for users of different physiques.

A seat air conditioner according to an aspect of the present disclosure is a seat air conditioner included in a seat including a seat back and a headrest that is height-adjustable and attached to an upper portion of the seat back, the seat air conditioner including: a blower provided inside the seat; and a first blowing port and a second blowing port that are formed in the seat back for blowing out air blown from the blower from the seat back, wherein the second blowing port is disposed below the first blowing port, and the first blowing port is opened and closed in conjunction with the height adjustment movement of the headrest.

Here, the vertical position of the headrest, which can be raised and lowered, is adjusted according to the physique of the seated user. For example, for a large user, the headrest is disposed at the top of the lift range, and for a small user, the headrest is disposed at the bottom of the lift range. In this aspect, the first blowing port above the second blowing port is opened and closed in conjunction with the height adjustment movement of this headrest. That is, since the open and closed state of the first blowing port can be switched between a large user and a small user, it is possible to blow air to an appropriate position for users of different physiques.

In addition, the headrest may be disposed higher when opening the first blowing port than when closing the first blowing port.

According to this, when the headrest opens the first blowing port, the headrest is disposed higher than when the headrest blocks the first blowing port, so in the case of a large user whose headrest is disposed at a high position, the first blowing port can be opened, and in the case of a small user whose headrest is disposed at a low position, the first blowing port can be blocked.

For example, if the installation location of the second blowing port is set appropriately for a small user, airflow from the first blowing port above the second blowing port will disturb the hair on the head of the small user, causing discomfort. In the case of a small user, the headrest is disposed at a low position and the first blowing port is blocked, so air is not blown from the first blowing port to the small user. Therefore, it is possible to suppress the discomfort felt by a small user.

On the other hand, if the installation location of the first blowing port is set appropriately for a large user, when the headrest is disposed at a high position, the first blowing port will be opened and air is appropriately blown towards the large user from the first blowing port. At this time, the second blowing port is blocked by the back of the large user, so that the large user is unlikely to feel uncomfortable.

With these things, it is possible to suppress the discomfort experienced by users of different physiques.

In addition, a plurality of first blowing ports may be arranged side by side in a horizontal direction when the seat back is viewed from a front, each of the plurality of first blowing ports being the first blowing port.

According to this, since the plurality of first blowing ports are provided side by side in a horizontal direction, air can be blown onto the neck of a large user from both the left and right sides. Since blood vessels are concentrated in the neck, it is possible to efficiently regulate the temperature of the blood vessels by blowing air to the left and right sides of the neck.

In addition, a plurality of second blowing ports may be arranged side by side in a horizontal direction when the seat back is viewed from a front, each of the plurality of second blowing ports being the second blowing port.

According to this, since the plurality of second blowing ports are provided side by side in a horizontal direction, air can be blown onto the neck of a small user from both the left and right sides. Since blood vessels are concentrated in the neck, it is possible to efficiently regulate the temperature of the blood vessels by blowing air to the left and right sides of the neck.

In addition, the headrest may be provided with an opening and closing portion that blocks the second blowing port when the first blowing port is open.

According to this, since the headrest is provided with an opening and closing portion that blocks the second blowing port when the first blowing port is open, air can be blown from the first blowing port with the second blowing port blocked with the opening and closing portion. Therefore, air can be intensively blown from the first blowing port.

In addition, the headrest may include a headrest stay to be inserted into the upper portion of the seat back, and the opening and closing portion may be attached to the headrest stay.

According to this, since the opening and closing portion is attached to the headrest stay of the headrest, the opening and closing portion can be operated in conjunction with the height adjustment movement of the headrest. Therefore, it is possible to efficiently open and close the second blowing port.

In addition, the headrest stay may be disposed at a position where the headrest stay does not overlap the second blowing port when the seat back is viewed from a front when the first blowing port is blocked by the opening and closing portion.

According to this, when the first blowing port is blocked by the opening and closing portion, the headrest stay is disposed at a position where the headrest stay does not overlap with the second blowing port, so when the first blowing port is blocked, it is possible to stably blow air from the second blowing port.

The headrest stay may be disposed at a position where the headrest stay does not overlap the first blowing port when the seat back is viewed from a front when the first blowing port is open.

According to this, when the first blowing port is open, the headrest stay is disposed at a position where the headrest stay does not overlap with the first blowing port, so it is possible to prevent the headrest stay from blocking the air blowing from the first blowing port.

In addition, a lower end of a main body portion of the headrest may be shaped to block the first blowing port when the headrest blocks the first blowing port, and to be exposed to air blown out from the first blowing port when the headrest opens the first blowing port.

According to this, since the lower end of the main body portion of the headrest is shaped to block the first blowing port when the headrest blocks the first blowing port, the air from the first blowing port can be blocked with this lower end. In addition, since the lower end of the main body portion is shaped to be exposed to air blown out from the first blowing port when the headrest opens the first blowing port, it is possible to change the traveling direction of a part of the air blown out from the first blowing port at this lower end. For example, it is possible to direct the air toward the neck of a large user while suppressing the air from directly hitting the head (hair) of the user. That is, it is possible to improve the cooling performance for the neck while reducing the discomfort of hair being disturbed.

In addition, the seat back may include an outer surface on which the first blowing port is formed, the lower end may include a facing surface facing the first blowing port, and a first spacing between a portion of the outer surface at a lower position than the first blowing port and the facing surface may be greater than a second spacing between a portion of the outer surface at a higher position than the first blowing port and the facing surface.

According to this, since the first spacing is larger than the second spacing, when the headrest does not completely block the first blowing port, the air that is blown out from the first blowing port and hits the lower portion of the main body portion of the headrest can be made to flow more easily toward a portion at a lower position than the first blowing port. This air flows downward and merges with the air blown out from the second blowing port. That is, the air after the merger also flows downward to some extent. Therefore, the air can be guided toward the neck of a small user.

In addition, the seat may include an active ingredient generator at a position leading to the first blowing port and the second blowing port.

According to this, since the active ingredient generator is provided at a position leading to the first blowing port and the second blowing port, the active ingredient generated by the active ingredient generator can be blown out on the air from the first blowing port and the second blowing port. Therefore, the active ingredient can be made to act on the user.

In addition, a guide path may be formed in the seat back to guide air from the blower to the first blowing port and the second blowing port, and the active ingredient generator may be disposed in the guide path.

According to this, since the active ingredient generator is disposed upstream of the first blowing port and the second blowing port in the guide path, an active ingredient can be contained in the air blown out from each of the first blowing port and the second blowing port using one active ingredient generator.

The active ingredient generator may be disposed near the first blowing port and the second blowing port.

According to this, since the active ingredient generator is disposed in the vicinity of the first blowing port and the second blowing port, the active ingredient just generated by the active ingredient generator can be included in the air blown out from each of the first blowing port and the second blowing port. Therefore, the active ingredient can act on the user before it deteriorates.

### Embodiment

It should be noted that each of the embodiments described below are comprehensive or specific examples. The numerical values, shapes, materials, components, arrangement positions and connection forms of the components, and the like shown in the following embodiments are merely examples, and are not intended to limit the present disclosure. Among the components in the following embodiments, the components not stated in the independent claims will be described as arbitrary components. Each figure is a schematic view and is not necessarily exactly illustrated. In each figure, the same components are designated by the same reference numerals.

Expressions indicating relative directions or orientations, such as parallel and orthogonal, include cases where directions or orientations are not strictly the directions or orientations. For example, “two directions are orthogonal” does not only mean that the two directions are completely orthogonal, but also mean that they are substantially orthogonal, that is, they include a difference of about a few percent, for example.

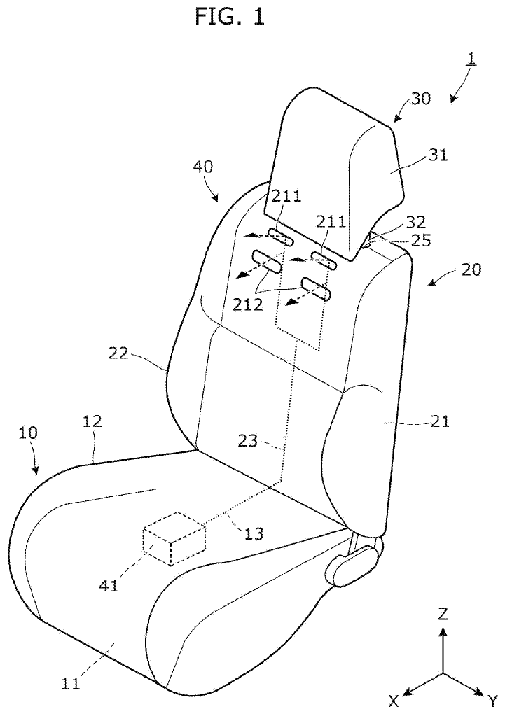

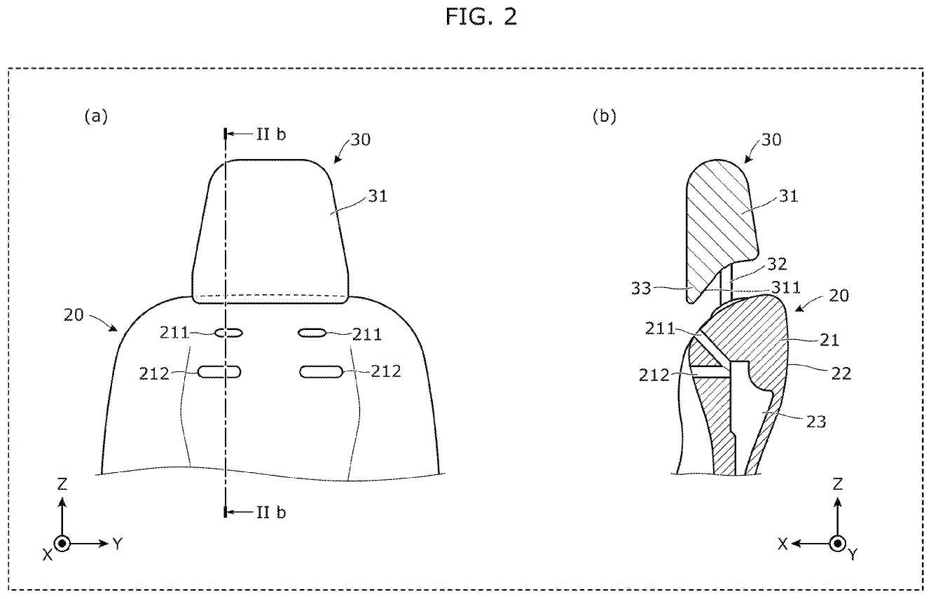

In the following description, the front-rear direction of the seat will be referred to as the X-axis direction, and the up-down direction of the seat will be referred to as the Z-axis direction. Furthermore, the left-right direction of the seat, that is, the direction perpendicular to each of the X-axis direction and the Z-axis direction is referred to as the Y-axis direction. The XY plane is a horizontal plane. In addition, the front side of the seat is referred to as the X-axis positive direction, and the rear side of the seat is referred to as the X-axis negative direction. The left side of the seat (front right side when viewing FIG. 1) is referred to as the Y-axis positive direction, and the opposite side is referred to as the Y-axis negative direction. The right side is the right side of the user with respect to the traveling direction of the vehicle when the user is seated on the seat, and is the negative direction of the Y-axis. The left side is the left side of the user with respect to the traveling direction of the vehicle when the user is seated on the seat, and is the positive direction of the Y axis. The upper side of the seat is referred to as the Z-axis positive direction, and the lower side of the seat is referred to as the Z-axis negative direction. The same applies to FIG. 2 and subsequent figures.

### <Seat>

FIG. 1 is a perspective view showing the appearance of seat 1 including seat air conditioner 40 according to an embodiment. As shown in FIG. 1, seat 1 is, for example, a seat included in a vehicle, and includes seat portion 10, seat back 20, headrest 30, and seat air conditioner 40.

Seat portion 10 is a seat cushion that supports the buttocks, thighs, and the like of a user seated on seat 1. Seat portion 10 includes first seat pad 11 corresponding to a cushioning material, and first seat cover 12 such as a leather cover, a textile cover, or the like, which covers first seat pad 11. First seat pad 11 has a recess formed therein, and blower 41, which is a part of seat air conditioner 40, is accommodated in the recess. Although not shown, first seat pad 11 is formed with an air intake path (not shown) that connects the outside of first seat pad 11 and blower 41 so that air is taken in from the air intake path when blower 41 is driven. In this embodiment, the intake path is connected to an air conditioner (not shown) provided in the vehicle, and warm air and cold air supplied from the air conditioner are transmitted to blower 41 via the intake path. It should be noted that blower 41 itself may have an air conditioning function. In addition, first guide path 13 is formed in first seat pad 11 to guide air blown from blower 41 to seat back 20.

Seat back 20 is a backrest portion that supports the acromion, back, and lumbar region of the user seated on seat 1. Seat back 20 is elongated in the Z-axis direction and is disposed so as to rise up from seat portion 10. Seat back 20 includes second seat pad 21 corresponding to a cushioning material, and second seat cover 22 such as a leather cover, a textile cover, or the like, which covers second seat pad 21.

Second seat pad 21 is made of, for example, urethane foam, and includes a structure at its lower end that allows the angle of the backrest to be adjusted. A pair of first blowing ports 211 and a pair of second blowing ports 212 arranged below first blowing ports 211 are provided on the upper front surface of second seat pad 21. The pair of first blowing ports 211 and the pair of second blowing ports 212 may be covered by second seat cover 22 to allow ventilation, or may be exposed from second seat cover 22. Details of the pair of first blowing ports 211 and the pair of second blowing ports 212 will be described later.

A pair of attachment holes 25 (only one is shown in FIG. 1) are provided in the upper portion of second seat pad 21 above the pair of first blowing ports 211. The pair of attachment holes 25 are holes to which headrest stays 32 of headrest 30 are attached, and extend in the Z-axis direction. The pair of attachment holes 25 are arranged at positions sandwiching the center of second seat pad 21 in the Y-axis direction. The pair of attachment holes 25 are exposed from second seat cover 22.

Second guide path 23 is formed in second seat pad 21 to guide the air that has passed through first guide path 13 of first seat pad 11 to each first blowing port 211 and each second blowing port 212. Specifically, second guide path 23 includes a proximal end communicating with first guide path 13 of the first seat pad, and branches into two in the middle, with one branch extending to one first blowing port 211 and one second blowing port 212, and the other branch extending to the other first blowing port 211 and the other second blowing port 212.

Headrest 30 is attached to the upper portion of seat back 20 so that it can be raised and lowered to adjust its height. Specifically, headrest 30 includes main body portion 31 and a pair of headrest stays 32. Main body portion 31 is a portion that supports the head of a user seated on seat 1 from the rear. Lower surface 311 of main body portion 31 is curved to follow the shape of the upper surface of seat back 20. Lower surface 311 of main body portion 31 overlaps the upper surface of seat back 20 when main body portion 31 is disposed at the lowest position by adjusting the height, thereby covering and blocking each of first blowing ports 211.

It should be noted that lower end 33 of main body portion 31 may be shaped to block first blowing port 211 when headrest 30 blocks first blowing port 211, and to be exposed to air blown out from blowing port 211 when headrest 30 opens first blowing port 211. As mentioned above, lower surface 311, which is a part of lower end 33 of main body portion 31, is curved to follow the shape of the upper surface of seat back 20. That is, lower end 33 is in a shape that protrudes downward, and lower surface 311 is an inclined surface that moves toward the negative Z-axis direction as it goes toward the positive direction of the X-axis. When main body portion 31 opens first blowing port 211, if lower end 33 is disposed at a position where lower end 33 is exposed to the air blown out from first blowing port 211, the traveling direction of the air can be changed by the air from first blowing port 211 hitting lower end 33.

The pair of headrest stays 32 are rods that extend downward from the lower portion of main body portion 31, and are members that are inserted into the pair of attachment holes 25 of second seat pad 21. The insertion length of each headrest stay 32 into each mounting hole 25 can be changed in stages, and at each stage, the position of headrest stay 32 in the vertical direction can be adjusted by being locked with a locking tool provided on second seat pad 21. That is, the vertical position of main body portion 31 can also be fixed in stages. Each first blowing port 211 can be opened and closed in conjunction with the height adjustment of headrest 30. A state in which each first blowing port 211 is opened is referred to as an open state, and a state in which each first blowing port 211 is blocked is referred to as a blocked state.

### <Seat Air Conditioner>

Next, seat air conditioner 40 according to the embodiment will be described. Seat air conditioner 40 includes blower 41 mentioned above, first blowing port 211, second blowing port 212, and headrest 30, so that first blowing port 211 is opened and closed in conjunction with the height adjustment movement of headrest 30.

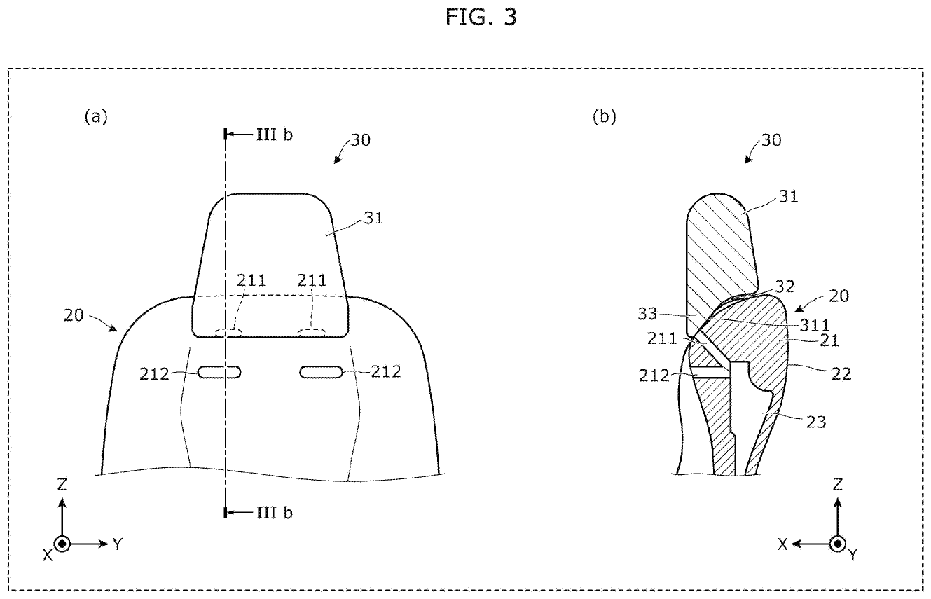

FIG. 2 is an explanatory diagram showing seat back 20 and headrest 30 in an open state according to the embodiment. FIG. 3 is an explanatory diagram showing seat back 20 and headrest 30 in a blocked state according to the embodiment. (a) in FIG. 2 and (a) in FIG. 3 are front views of seat back 20 and headrest 30. The front view is a view of seat back 20 and headrest 30 viewed from the positive direction of the X-axis. That is, viewing seat back 20 and headrest 30 from the front corresponds to viewing these from the positive direction of the X-axis. (b) in FIG. 2 is a cross-sectional view taken along line IIb-IIb in (a) in FIG. 2. (b) in FIG. 3 is a cross-sectional view taken along line IIIb-IIIb in (a) in FIG. 3.

As shown in FIG. 2 and FIG. 3, the pair of first blowing ports 211 are arranged side by side in the Y-axis direction (horizontal direction) at positions where the center of second seat pad 21 in the Y-axis direction is sandwiched. In cross-sectional view, each first blowing port 211 is formed to be inclined toward the Z-axis plus direction as it goes in the X-axis plus direction.

The pair of second blowing ports 212 are arranged below the pair of first blowing ports 211, and are arranged side by side in the Y-axis direction (horizontal direction) at positions where the center of second seat pad 21 in the Y-axis direction is sandwiched. In cross-sectional view, each second blowing port 212 is formed parallel to the X-axis direction.

In front view, one of first blowing ports 211 and one of second blowing ports 212 are arranged at approximately the same position in the Y-axis direction, and the other of first blowing ports 211 and the other of second blowing ports 212 are arranged at approximately the same position in the Y-axis direction.

As shown in FIG. 2, in the open state, main body portion 31 of headrest 30 is located higher than in the blocked state, and main body portion 31 does not cover the pair of first blowing ports 211 and is open.

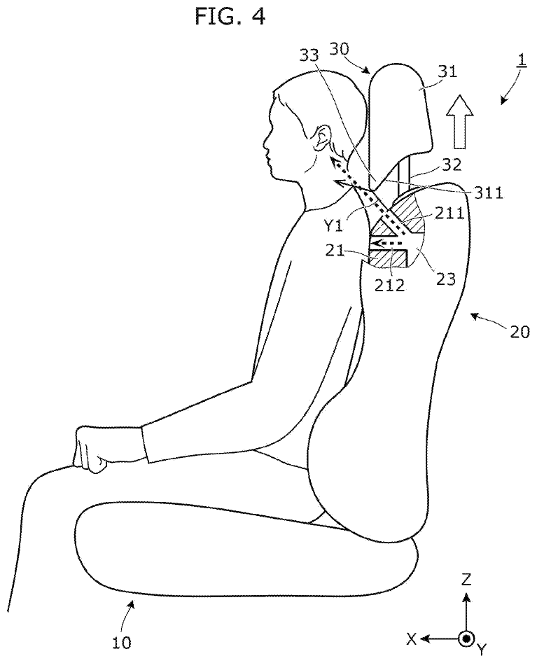

FIG. 4 shows a state in which a large user is seated on seat 1 in the open state according to the embodiment. As shown in FIG. 4, the pair of first blowing ports 211 are exposed when a large user is seated, and are arranged at positions where air can be blown toward the vicinity of the user's neck. Accordingly, the air from the pair of first blowing ports 211 flows in such a direction as to pinch the neck of a large user. On the other hand, the pair of second blowing ports 212 are arranged at positions where they are blocked by the back of a large user when the user is seated.

At this time, the air blown out from each first blowing port 211 advances toward the user with a constant spread. For this reason, a part of the air hits lower end 33 of main body portion 31, so that the traveling direction of the part of the air changes. Specifically, a part of the air hits lower end 33 and flows toward the neck of a large user (see arrow Y1 in FIG. 4).

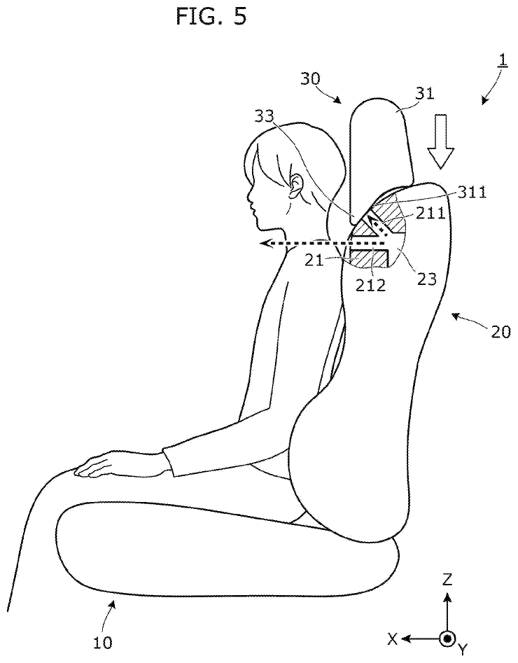

FIG. 5 shows a state in which a small user is seated on seat 1 in the blocked state according to the embodiment. In this case, main body portion 31 of headrest 30 is located below the position in the open state, and main body portion 31 covers and blocks a pair of first blowing ports 211. The pair of second blowing ports 212 are arranged at positions above the shoulders of a user who is smaller than a large user when the user is seated. That is, the pair of second blowing ports 212 are arranged at positions where the pair of second blowing ports 212 are exposed when a small user is seated, and can blow air toward the vicinity of the user's neck. Accordingly, the air from the pair of second blowing ports 212 flows in such a direction as to pinch the neck of a small user.

### Effects

As described above, the seat air conditioner according to the embodiment is seat air conditioner 40 included in seat 1 including seat back 20 and headrest 30 that is height-adjustable and attached to the upper portion of seat back 20. Seat air conditioner 40 includes: blower 41 provided inside seat 1; first blowing port 211 and second blowing port 212 that are formed in seat back 20 for blowing out the air blown from blower 41 from seat back 20; and headrest 30. Second blowing port 212 is disposed below first blowing port 211, and first blowing port 211 is opened and closed in conjunction with the height adjustment movement of headrest 30.

Here, the vertical position of headrest 30, which can be raised and lowered, is adjusted according to the physique of the seated user. For example, for a large user, headrest 30 is disposed at the top of the lift range, and for a small user, headrest 30 is disposed at the bottom of the lift range. In this embodiment, first blowing port 211 above second blowing port 212 is opened and closed in conjunction with the height adjustment movement of the headrest. That is, since the open and closed state of first blowing port 211 can be switched between a large user and a small user, it is possible to blow air to an appropriate position for users of different physiques.

In addition, when first blowing port 211 is opened, headrest 30 is disposed higher than when first blowing port 211 is blocked.

According to this, when headrest 30 opens first blowing port 211, headrest 30 is disposed higher than when headrest 30 blocks first blowing port 211, so in this case of a large user whose headrest 30 is disposed at a high position, first blowing port 211 can be opened, and in the case of a small user whose headrest 30 is disposed at a low position, first blowing port 211 can be blocked.

For example, if the installation location of second blowing port 212 is set appropriately for a small user, airflow from first blowing port 211 above second blowing port 212 will disturb the hair on the head of the small user, causing discomfort. In the case of a small user, headrest 30 is disposed at a low position and first blowing port 211 is blocked, so air is not blown from first blowing port 211 to the small user. Therefore, it is possible to suppress the discomfort felt by a small user.

On the other hand, if the installation location of first blowing port 211 is set appropriately for a large user, when headrest 30 is disposed at a high position, first blowing port 211 will be opened and air is appropriately blown towards the large user from the first blowing port. At this time, second blowing port 212 is blocked by the back of the large user, so that the large user is unlikely to feel uncomfortable.

With these things, it is possible to suppress the discomfort experienced by users of different physiques.

In addition, a plurality of first blowing ports 211 are provided side by side in the horizontal direction when seat back 20 is viewed from the front.

According to this, since the plurality of first blowing ports 211 are provided side by side in the horizontal direction, air can be blown onto the neck of a large user from both the left and right sides. Since blood vessels are concentrated in the neck, it is possible to efficiently regulate the temperature of the blood vessels by blowing air to the left and right sides of the neck.

In addition, a plurality of second blowing ports 212 are provided side by side in the horizontal direction when seat back 20 is viewed from the front.

According to this, since the plurality of second blowing ports 212 are provided side by side in the horizontal direction, air can be blown onto the neck of a small user from both the left and right sides. Since blood vessels are concentrated in the neck, it is possible to efficiently regulate the temperature of the blood vessels by blowing air to the left and right sides of the neck.

In addition, lower end 33 of main body portion 31 of headrest 30 is shaped to block first blowing port 211 when headrest 30 blocks first blowing port 211, and to be exposed to air blown out from first blowing port 211 when headrest 30 opens first blowing port 211.

According to this, since lower end 33 of main body portion 31 of headrest 30 is shaped to block first blowing port 211 when headrest 30 blocks first blowing port 211, the air from first blowing port 211 can be blocked with this lower end 33. In addition, since lower end 33 of main body portion 31 is shaped to be exposed to air blown out from first blowing port 211 when headrest 30 opens first blowing port 211, it is possible to change the traveling direction of a part of the air blown out from first blowing port 211 at this lower end 33. For example, it is possible to direct the air toward the neck of a large user while suppressing the air from directly hitting the head (hair) of the user. That is, it is possible to improve the cooling performance for the neck while reducing the discomfort of hair being disturbed.

### VARIATIONS

Variations of the above embodiment will be described below. In the following description, parts that are the same as those in the above embodiment may be designated by the same reference numerals, and the description thereof may be omitted.

### Variation 1

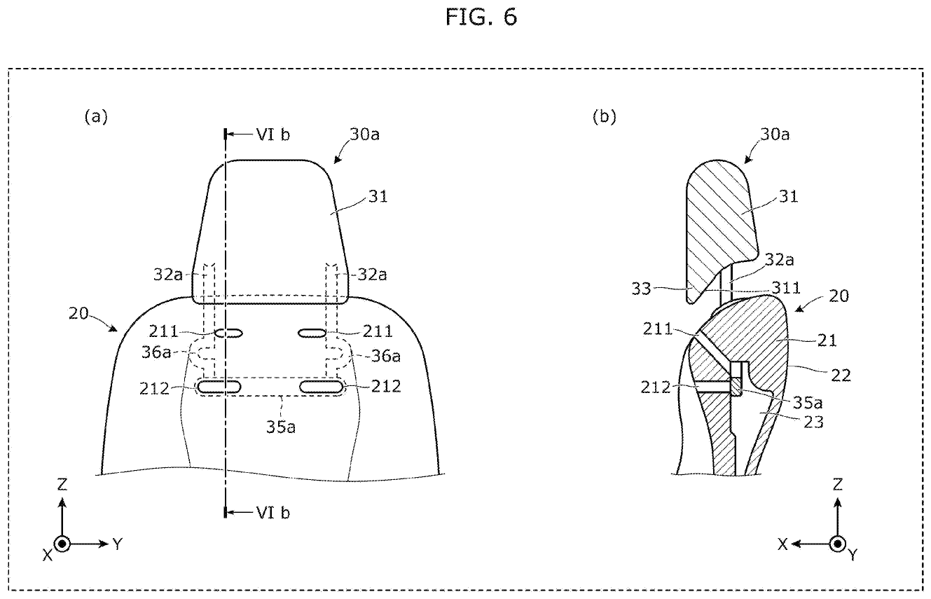

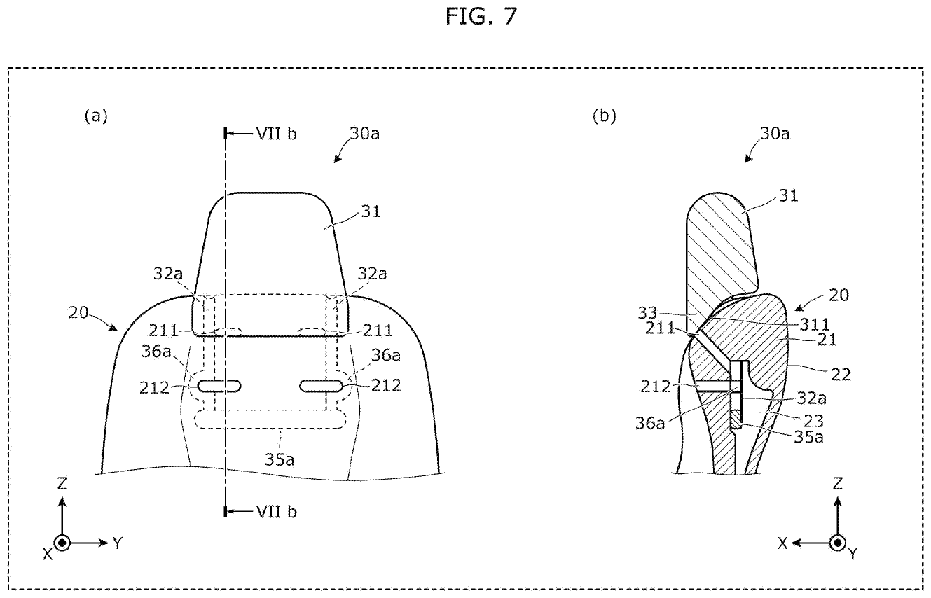

FIG. 6 is an explanatory diagram showing seat back 20 and headrest 30 in an open state according to Variation 1. FIG. 7 is an explanatory diagram showing seat back 20 and headrest 30 in a blocked state according to Variation 1. (a) in FIG. 6 and (a) in FIG. 7 are front views of seat back 20 and headrest 30. (b) in FIG. 6 is a cross-sectional view taken along line VIb-VIb in (a) in FIG. 6. (b) in FIG. 7 is a cross-sectional view taken along line VIIb-VIIb in (a) in FIG. 7.

Variation 1 differs from the above embodiment in that headrest 30a is provided with opening and closing portion 35a that opens and closes second blowing port 212 when first blowing port 211 is open. In headrest 30a according to Variation 1, opening and closing portion 35a is fixed to the lower portion of the pair of headrest stays 32a. Opening and closing portion 35a is a flat plate that is elongated in the Y-axis direction, and is formed in a size in which the pair of second blowing ports 212 can be blocked. In addition, curved portion 36a that curves outward is formed in the middle portion of the pair of headrest stays 32a.

As shown in FIG. 6, in the open state, opening and closing portion 35a is disposed at a position where opening and closing portion 35a covers and blocks the pair of second blowing ports 212. In addition, in the open state, curved portion 36a is disposed between each first blowing port 211 and each second blowing port 212. In the open state, each headrest stay 32a does not overlap first blowing port 211.

As shown in FIG. 7, in the blocked state, opening and closing portion 35a is disposed below the pair of second blowing ports 212. In addition, in the blocked state, curved portions 36a are arranged at positions corresponding to the pair of second blowing ports 212, but curved portions 36a are arranged at positions where curved portions 36a do not overlap with respective second blowing ports 212. For this reason, each second blowing port 212 maintains an open state.

As described above, headrest 30a is provided with opening and closing portion 35a that blocks second blowing ports 212 when first blowing ports 211 are open.

According to this, since headrest 30a is provided with the opening and closing portion that blocks second blowing ports 212 when first blowing ports 211 are open, air can be blown from first blowing port 211 with second blowing ports 212 blocked by opening and closing portion 35a. Therefore, air can be intensively blown from first blowing port 211.

In addition, headrest 30a includes headrest stay 32a inserted into the upper portion of seat back 20, and opening and closing portion 35a is attached to headrest stay 32a.

According to this, since opening and closing portion 35a is attached to headrest stay 32a of headrest 30a, opening and closing portion 35a can be operated in conjunction with the height adjustment movement of headrest 30a. Therefore, it is possible to open and close second blowing port 212 efficiently.

In addition, headrest stay 32a is disposed at a position where headrest stay 32a does not overlap second blowing port 212 when seat back 20 is viewed from the front when first blowing port 211 is blocked by opening and closing portion 35a.

According to this, when first blowing port 211 is blocked by opening and closing portion 35a, headrest stay 32a is disposed at a position where headrest stay 32a does not overlap second blowing port 212, so it is possible to stably blow air from second blowing port 212 when first blowing port 211 is blocked.

It should be noted that in this case, headrest stay 32a may not be disposed at a position where headrest stay 32a does not completely overlap second blowing port 212 when seat back 20 is viewed from the front, and as long as a part of second blowing port 212 is exposed, air can be blown from the part.

In addition, when first blowing port 211 is open, headrest stay 32a is disposed at a position where headrest stay 32a does not overlap first blowing port 211 when seat back 20 is viewed from the front.

According to this, when first blowing port 211 is open, headrest stay 32a is disposed at a position where headrest stay 32a does not overlap with first blowing port 211, so it is possible to prevent headrest stay 32a from blocking the air blowing from first blowing port 211.

It should be noted that in this case, headrest stay 32a may not be disposed at a position where headrest stay 32a does not overlap with first blowing port 211 when seat back 20 is viewed from the front, and as long as headrest stay 32a exposes a part of first blowing port 211, air can be blown from the part.

### Variation 2

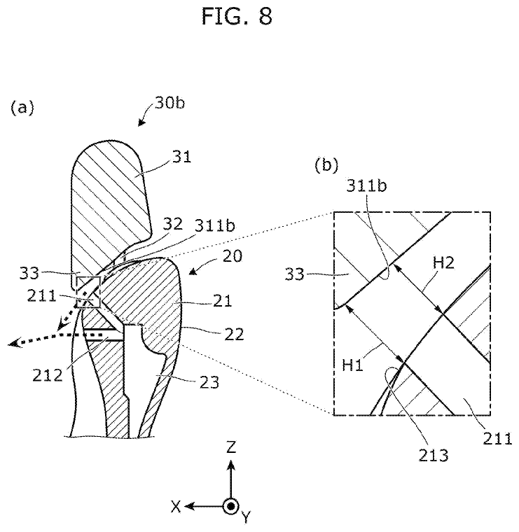

FIG. 8 is an explanatory diagram showing seat back 20 and headrest 30b according to Variation 2. (a) in FIG. 8 is a cross-sectional view showing a state in which headrest 30b does not completely block first blowing port 211. (b) in FIG. 8 is an enlarged cross-sectional view of a part of seat back 20 and headrest 30b.

As shown in FIG. 8, lower surface 311b, which is a part of lower end 33 of headrest 30b, faces outer surface 213 of seat back 20 where first blowing port 211 is formed. That is, lower surface 311b is an example of the facing surface. Here, first spacing H1 between a portion of outer surface 213 at a lower position than first blowing port 211 and lower surface 311b is larger than second spacing H2 between a portion of outer surface 213 at a higher position than first blowing port 211 and lower surface 311b.

In this way, since first spacing H1 is larger than second spacing H2, when headrest 30b does not completely block first blowing port 211, the air blown out from first blowing port 211 and hitting lower end 33 of main body portion 31 of headrest 30b can flow more easily toward the direction lower than first blowing port 211. This air flows downward and merges with the air blown out from second blowing port 212. That is, the air after the merger also flows downward to some extent. Therefore, the air can be guided toward the neck of a small user.

### Variation 3

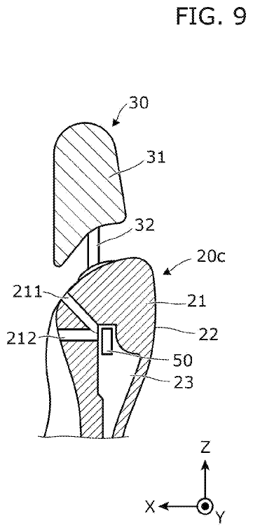

FIG. 9 is an explanatory diagram showing seat back 20c and headrest 30 according to Variation 3. As shown in FIG. 9, seat back 20c incorporate active ingredient generator 50 that is a part of the seat air conditioner. Active ingredient generator 50 is a device that generates an active ingredient. It should be noted that the “active ingredient” of the present disclosure is only needed to be any ingredient that can achieve at least one of, for example, virus inactivation, sterilization, deodorization, moisturizing, freshness preservation, and the like. Examples of active ingredients include a charged fine particle liquid containing OH radicals, OH radicals, O2 radicals, negative ions, positive ions, ozone, nitrate ions, and the like.

Active ingredient generator 50 is disposed within seat back 20c at a position leading to first blowing port 211 and second blowing port 212. Specifically, one active ingredient generator 50 is disposed in the vicinity of a branch point where first blowing port 211 and second blowing port 212 are branched into in second guide path 23.

In this way, since active ingredient generator 50 is provided at a position leading to first blowing port 211 and second blowing port 212, the active ingredient generated by active ingredient generator 50 can be blown out on the air from first blowing port 211 and second blowing port 212. Therefore, the active ingredient can be made to act on the user.

In addition, second guide path 23 (a guide path) is formed in seat back 20c to guide the air from blower 41 to first blowing port 211 and second blowing port 212, and active ingredient generator 50 may be disposed in second guide path 23.

According to this, since active ingredient generator 50 is disposed in second guide path 23, the active ingredient can be included in the air blown out from each of first blowing port 211 and second blowing port 212 using one active ingredient generator 50.

In addition, the active ingredient generator is arranged in the vicinity of the first blowing port and the second blowing port.

According to this, since active ingredient generator 50 is disposed in the vicinity of first blowing port 211 and second blowing port 212, the active ingredient just generated by active ingredient generator 50 can be included in the air blown out from each of first blowing port 211 and second blowing port 212. Therefore, the active ingredient can act on the user before it deteriorates.

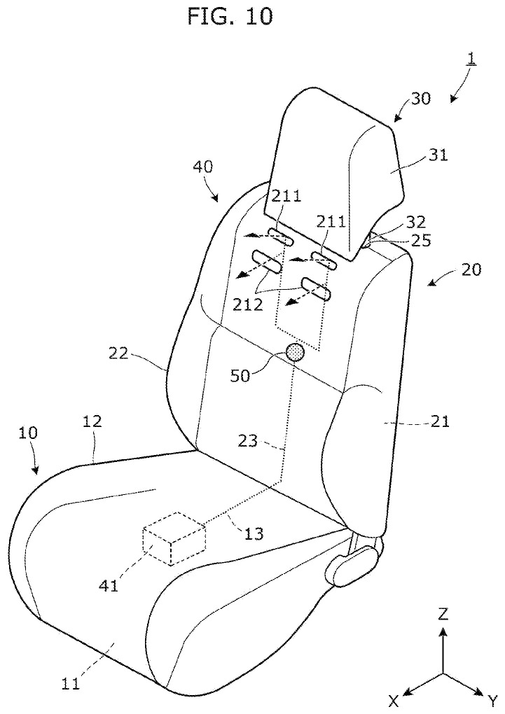

FIG. 10 is an explanatory diagram showing another installation position of active ingredient generator 50 according to Variation 3. As shown in FIG. 10, active ingredient generator 50 may be provided in the vicinity of a branch point of the pair of branch paths of second guide path 23, more specifically at a point upstream of the branch point. In this case, one active ingredient generator 50 can supply the active ingredient to each of the pair of first blowing ports 211 and the pair of second blowing ports 212. It should be noted that active ingredient generator 50 may be disposed inside each first blowing ports 211 and each second blowing port 212, or may be disposed within first guide path 13.

### Others

In addition, forms obtained by applying various modifications to the embodiment conceived by a person skilled in the art or forms realized by arbitrarily combining the components and functions in the embodiment without departing from the spirit of the present disclosure are also included in this disclosure.

For example, in the embodiment described above, seat air conditioner 40 included in a vehicle seat has been described as an example, but the seat air conditioner according to the present disclosure may be provided in a seat other than the vehicle seat. Other seats may be any seat equipped with a headrest that can be raised and lowered, and examples include an office chair, a gaming chair, a sofa, and the like.

In the above embodiment, a form is exemplified in which first blowing port 211 is opened and closed in conjunction with the height adjustment movement of headrest 30 due to the mechanical structure. However, the seat air conditioner may include a sensor that detects the height adjustment movement of the headrest, an opening and closing mechanism for opening and closing the first blowing port, and a controller that controls the opening and closing mechanism based on the detection result of the sensor. In this case, the controller is only needed to open and close the first blowing port by operating the opening and closing mechanism based on the detection result of the sensor.

### Additional Notes

The following technologies are disclosed by the description of the embodiment above.

### Technology 1

A seat air conditioner included in a seat including a seat back and a headrest that is height-adjustable and attached to an upper portion of the seat back, the seat air conditioner including: a blower provided inside the seat; and a first blowing port and a second blowing port that are formed in the seat back for blowing out air blown from the blower from the seat back, wherein the second blowing port is disposed below the first blowing port, and the first blowing port is opened and closed in conjunction with a height adjustment movement of the headrest.

With this configuration, the first blowing port above the second blowing port is opened and closed in conjunction with the height adjustment movement of the headrest. That is, since the open and closed state of the first blowing port can be switched between a large user and a small user, it is possible to blow air to an appropriate position for users of different physiques.

### Technology 2

The seat air conditioner according to technology 1, wherein when the first blowing port is opened, the headrest is disposed higher than when the first blowing port is blocked.

With this configuration, when the headrest opens the first blowing port, the headrest is disposed higher than when the headrest blocks the first blowing port, so in the case of a large user whose headrest is disposed at a high position, the first blowing port can be opened, and in the case of a small user whose headrest is disposed at a low position, the first blowing port can be blocked.

For example, if the installation location of the second blowing port is set appropriately for a small user, airflow from the first blowing port above the second blowing port will disturb the hair on the head of the small user, causing discomfort. In the case of a small user, the headrest is disposed at a low position and the first blowing port is blocked, so air is not blown from the first blowing port to the small user. Therefore, it is possible to suppress the discomfort felt by a small user.

On the other hand, if the installation location of the first blowing port is set appropriately for a large user, when the headrest is disposed at a high position, the first blowing port will be opened and air is appropriately blown towards the large user from the first blowing port. At this time, the second blowing port is blocked by the back of the large user, so that the large user is unlikely to feel uncomfortable.

With these things, it is possible to suppress the discomfort experienced by users of different physiques.

### Technology 3

The seat air conditioner according to technology 1 or 2, wherein a plurality of first blowing ports are arranged side by side in a horizontal direction when the seat back is viewed from a front, each of the plurality of first blowing ports being the first blowing port.

With this configuration, since the plurality of first blowing ports are provided side by side in a horizontal direction, air can be blown onto the neck of a large user from both the left and right sides. Since blood vessels are concentrated in the neck, it is possible to efficiently regulate the temperature of the blood vessels by blowing air to the left and right sides of the neck.

### Technology 4

The seat air conditioner according to any one of technologies 1 to 3, wherein a plurality of second blowing ports are arranged side by side in a horizontal direction when the seat back is viewed from a front, each of the plurality of second blowing ports being the second blowing port.

With this configuration, since the plurality of second blowing ports are provided side by side in a horizontal direction, air can be blown onto the neck of a small user from both the left and right sides. Since blood vessels are concentrated in the neck, it is possible to efficiently regulate the temperature of the blood vessels by blowing air to the left and right sides of the neck.

### Technology 5

The seat air conditioner according to any one of technologies 1 to 4, wherein the headrest is provided with an opening and closing portion that blocks the second blowing port when the first blowing port is open.

With this configuration, since the headrest is provided with an opening and closing portion that blocks the second blowing port when the first blowing port is open, air can be blown from the first blowing port with the second blowing port blocked with the opening and closing portion. Therefore, air can be intensively blown from the first blowing port.

### Technology 6

The seat air conditioner according to technology 5, wherein the headrest includes a headrest stay to be inserted into the upper portion of the seat back, and the opening and closing portion is attached to the headrest stay.

With this configuration, since the opening and closing portion is attached to the headrest stay of the headrest, the opening and closing portion can be operated in conjunction with the height adjustment movement of the headrest. Therefore, it is possible to efficiently open and close the second blowing port.

### Technology 7

The seat air conditioner according to technology 6, wherein the headrest stay is disposed at a position where the headrest stay does not overlap the second blowing port when the seat back is viewed from a front when the first blowing port is blocked by the opening and closing portion.

With this configuration, when the first blowing port is blocked by the opening and closing portion, the headrest stay is disposed at a position where the headrest stay does not overlap with the second blowing port, so when the first blowing port is blocked, it is possible to stably blow air from the second blowing port.

### Technology 8

The seat air conditioner according to technology 6 or 7, wherein the headrest stay is disposed at a position where the headrest stay does not overlap the first blowing port when the seat back is viewed from a front when the first blowing port is open.

With this configuration, when the first blowing port is open, the headrest stay is disposed at a position where the headrest stay does not overlap with the first blowing port, so it is possible to prevent the headrest stay from blocking the air blowing from the first blowing port.

### Technology 9

The seat air conditioner according to any one of technologies 1 to 8, wherein a lower end of a main body portion of the headrest is shaped to block the first blowing port when the headrest blocks the first blowing port, and to be exposed to air blown out from the first blowing port when the headrest opens the first blowing port.

With this configuration, since the lower end of the main body portion of the headrest is shaped to block the first blowing port when the headrest blocks the first blowing port, the air from the first blowing port can be blocked with this lower end. In addition, since the lower end of the main body portion is shaped to be exposed to air blown out from the first blowing port when the headrest opens the first blowing port, it is possible to change the traveling direction of a part of the air blown out from the first blowing port at this lower end. For example, it is possible to direct the air toward the neck of a large user while suppressing the air from directly hitting the head (hair) of the user. That is, it is possible to improve the cooling performance for the neck while reducing the discomfort of hair being disturbed.

### Technology 10

The seat air conditioner according to technology 9, wherein the seat back includes an outer surface on which the first blowing port is formed, the lower end includes a facing surface facing the first blowing port, and a first spacing between a portion of the outer surface at a lower position than the first blowing port and the facing surface is greater than a second spacing between a portion of the outer surface at a higher position than the first blowing port and the facing surface.

With this configuration, since the first spacing is larger than the second spacing, when the headrest does not completely block the first blowing port, the air that is blown out from the first blowing port and hits the lower portion of the main body portion of the headrest can be made to flow more easily toward a portion at a lower position than the first blowing port. This air flows downward and merges with the air blown out from the second blowing port. That is, the air after the merger also flows downward to some extent. Therefore, the air can be guided toward the neck of a small user.

### Technology 11

The seat air conditioner according to any one of technologies 1 to 10, wherein the seat includes an active ingredient generator at a position leading to the first blowing port and the second blowing port.

With this configuration, since the active ingredient generator is provided at a position leading to the first blowing port and the second blowing port, the active ingredient generated by the active ingredient generator can be blown out on the air from the first blowing port and the second blowing port. Therefore, the active ingredient can be made to act on the user.

### Technology 12

The seat air conditioner according to technology 11, wherein a guide path is formed in the seat back to guide air from the blower to the first blowing port and the second blowing port, and the active ingredient generator is disposed in the guide path.

With this configuration, since the active ingredient generator is disposed upstream of the first blowing port and the second blowing port in the guide path, an active ingredient can be contained in the air blown out from each of the first blowing port and the second blowing port using one active ingredient generator.

### Technology 13

The seat air conditioner according to technology 12, wherein the active ingredient generator is disposed near the first blowing port and the second blowing port.

With this configuration, since the active ingredient generator is disposed near the first blowing port and the second blowing port, the active ingredient just generated by the active ingredient generator can be included in the air blown out from each of the first blowing port and the second blowing port. Therefore, the active ingredient can act on the user before it deteriorates.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2021-212458 filed on Dec. 27, 2021, Japanese Patent Application No. 2022-114603 filed on Jul. 19, 2022, and PCT International Application No. PCT/JP2022/039852 filed on Oct. 26, 2022.

### INDUSTRIAL APPLICABILITY

The present disclosure can be used, for example, in a seat equipped with a height-adjustable headrest.

1. A seat air conditioner included in a seat including a seat back and a headrest that is height-adjustable and attached to an upper portion of the seat back, the seat air conditioner comprising:
a blower provided inside the seat; and
a first blowing port and a second blowing port that are formed in the seat back for blowing out air blown from the blower from the seat back,
wherein the second blowing port is disposed below the first blowing port, and
the first blowing port is opened and closed in conjunction with a height adjustment movement of the headrest.

2. The seat air conditioner according to claim 1,
wherein when the first blowing port is opened, the headrest is disposed higher than when the first blowing port is blocked.

3. The seat air conditioner according to claim 1,
wherein a plurality of first blowing ports are arranged side by side in a horizontal direction when the seat back is viewed from a front, each of the plurality of first blowing ports being the first blowing port.

4. The seat air conditioner according to claim 1,
wherein a plurality of second blowing ports are arranged side by side in a horizontal direction when the seat back is viewed from a front, each of the plurality of second blowing ports being the second blowing port.

5. The seat air conditioner according to claim 1,
wherein the headrest is provided with an opening and closing portion that blocks the second blowing port when the first blowing port is open.

6. The seat air conditioner according to claim 5,
wherein the headrest includes a headrest stay to be inserted into the upper portion of the seat back, and
the opening and closing portion is attached to the headrest stay.

7. The seat air conditioner according to claim 6,
wherein the headrest stay is disposed at a position where the headrest stay does not overlap the second blowing port when the seat back is viewed from a front when the first blowing port is blocked by the opening and closing portion.

8. The seat air conditioner according to claim 6,
wherein the headrest stay is disposed at a position where the headrest stay does not overlap the first blowing port when the seat back is viewed from a front when the first blowing port is open.

9. The seat air conditioner according to claim 1,
wherein a lower end of a main body portion of the headrest is shaped to block the first blowing port when the headrest blocks the first blowing port, and to be exposed to air blown out from the first blowing port when the headrest opens the first blowing port.

10. The seat air conditioner according to claim 9,
wherein the seat back includes an outer surface on which the first blowing port is formed,
the lower end includes a facing surface facing the first blowing port, and
a first spacing between a portion of the outer surface at a lower position than the first blowing port and the facing surface is greater than a second spacing between a portion of the outer surface at a higher position than the first blowing port and the facing surface.

11. The seat air conditioner according to claim 1,
wherein the seat includes an active ingredient generator at a position leading to the first blowing port and the second blowing port.

12. The seat air conditioner according to claim 11,
wherein a guide path is formed in the seat back to guide air from the blower to the first blowing port and the second blowing port, and
the active ingredient generator is disposed in the guide path.

13. The seat air conditioner according to claim 12,
wherein the active ingredient generator is disposed near the first blowing port and the second blowing port.
